(19) United States
(12) Patent Application Publication
(10) Pub. No.: US 2006/0010285 A1
(43) Pub. Date: Jan. 12, 2006

(54) Virtual storage for removable storage media

(75) Inventor: Steven P. Georgis, Boulder, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ProStor Systems, Inc., Boulder, CO (US)

(21) Appl. No.: 11/149,919

(22) Filed: Jun. 10, 2005

Related U.S. Application Data
(60) Provisional application No. 60/586,080, filed on Jul. 6, 2004.

(51) Int. Cl. G06F 12/00

(52) U.S. Cl. 711/111

(57) ABSTRACT

According to the invention, a storage system for emulating a first interface command set different from a second interface command set of a second interface is disclosed. The storage system includes an interface connector, an interface circuit, an interface driver, and a cartridge controller. The interface connector is configured to removably couple with a storage cartridge, which includes the second interface and uses the second interface command set. The interface circuit is coupled to the interface connector. The interface driver manages operation of the interface circuit. The cartridge controller uses the first interface command set and is logically coupled to the interface driver. The cartridge controller software translates the first interface command set for the interface driver. The first interface command set is for tape drives.

This application claims the benefit of and is a non-provisional of U.S. Provisional Application Ser. No. 60/586,080 filed on Jul. 6, 2004, which is incorporated by reference in its entirety for all purposes.

This application incorporates by reference U.S. Provisional Patent Application Ser. No. 60/586,087, filed on Jul. 6, 2004, in its entirety for all purposes.

### BACKGROUND OF THE DISCLOSURE

This disclosure relates in general to storage systems and, more specifically, but not by way of limitation, to data storage cartridge systems.

Conventional tape backup systems have software already adapted to operate the tape backup systems. As new tape backup systems are developed, there can be a delay before the software is updated to properly interact with the new tape backup system. In some cases, the manufacturer of the new tape backup system will develop a driver or customized software to allow use of their new system.

There are standard command sets used to interface with classes of tape backup systems. Developers can make a new tape backup system that use the standard command set. Most legacy software can operate with the new tape backup system if the interface is done properly. Conventional command sets do not accommodate many new types of storage media.

### BRIEF DESCRIPTION OF THE DRAWINGS

The present disclosure is described in conjunction with the appended figures:

FIG. 1 is a block diagram of an embodiment of a conventional tape drive system;

FIG. 2 is a block diagram of an embodiment of a conventional software/hardware stack;

FIG. 3A is a block diagram of an embodiment of a hardware-controlled removable cartridge device removably coupled to a data cartridge;

FIG. 3B is a block diagram of an embodiment of a software/hardware stack for the embodiment of FIG. 3A;

FIG. 4A is a block diagram of an embodiment of the data cartridge;

FIG. 4B is a block diagram of an embodiment of the data cartridge coupled to a cartridge holder;

FIG. 5A is a block diagram of an embodiment of a backup system that includes a software-controlled removable cartridge device removably coupled to a data cartridge;

FIG. 5B is a block diagram of an embodiment of the software/hardware stack for the embodiment of FIG. 5A;

FIG. 6A is a block diagram of an embodiment of portions of the removable cartridge device of FIGS. 3A and 3B;

FIG. 6B is a block diagram of an embodiment of the architecture of the system controller software, which implements the control and formatting functions removable cartridge device shown in FIG. 3A; and

FIG. 7 is a block diagram of an embodiment of the architecture of the host system components interacting with a data cartridge for the embodiment of FIG. 5A and 5B.

In the appended figures, similar components and/or features may have the same reference label. Where the same reference label is used in the specification, the description is applicable to any one of the similar components having the same reference label.

### DETAILED DESCRIPTION OF THE PREFERRED EMBODIMENT

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment or computer-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The invention relates to computer data storage systems used for data backup, restore and archive applications. It specifically relates to a new generation of removable data cartridges housing a hard disk drive (HDD) as the storage medium and whose interface to the system is an electrical connection having no mechanical interface to the data cartridge during operation (e.g., drive head actuators, tape drive mechanics, etc.). Other embodiments can use any type of storage medium in the data cartridge (e.g. flash memory) so long as there is no mechanical interface. Some embodiments may use autoloaders to mechanically insert, remove and lock the data cartridge in a cartridge holder.

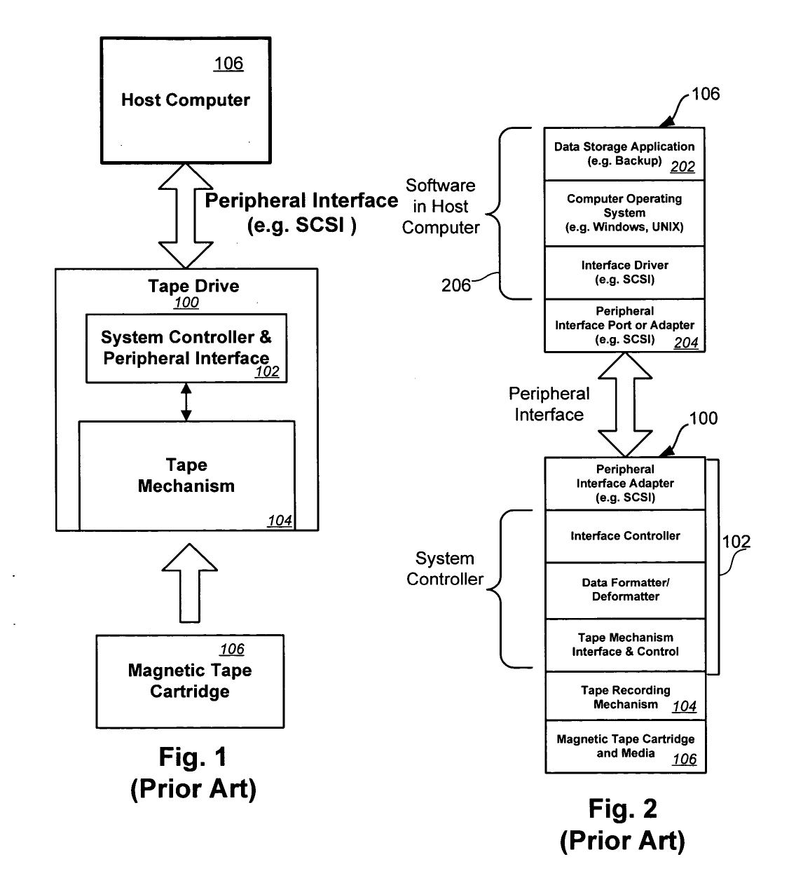

Referring first to FIG. 1, a conventional tape drive peripheral 100 connected to a host computer 106 by means of a peripheral interface is shown. The conventional tape drive system is has three parts: a system controller and peripheral interface 102 having both electronics and software; a tape recording mechanism 104 including a tape transport, motors, heads, a cartridge loader, etc.; and the tape cartridge 106 including a magnetic tape media on one or two reels.

The operation of the conventional tape drive system 100 also involves software and hardware stack inside the host computer 106 as depicted in FIG. 2. At the top of the stack in FIG. 2 is the data storage application 202 which interfaces through the computer operating system (OS) to the interface driver software that operates the hardware (HW) interface port or adapter (e.g., SCSI, PATA, SATA, SAS, Firewire™, ethernet, UWB, Bluetooth™, WiFi, USB, wireless USB, etc.), which communicates across a cable or port to the tape drive 100. Inside the tape drive 100, the system controller and peripheral interface (SCPI) 102 consists of hardware and software the control the peripheral interface, receive the data, format the data, and control a tape mechanism 104. The general flow of data through the entire stack is top-to-bottom for the recording process in FIG. 2 and bottom-to-top for the restore or read process.

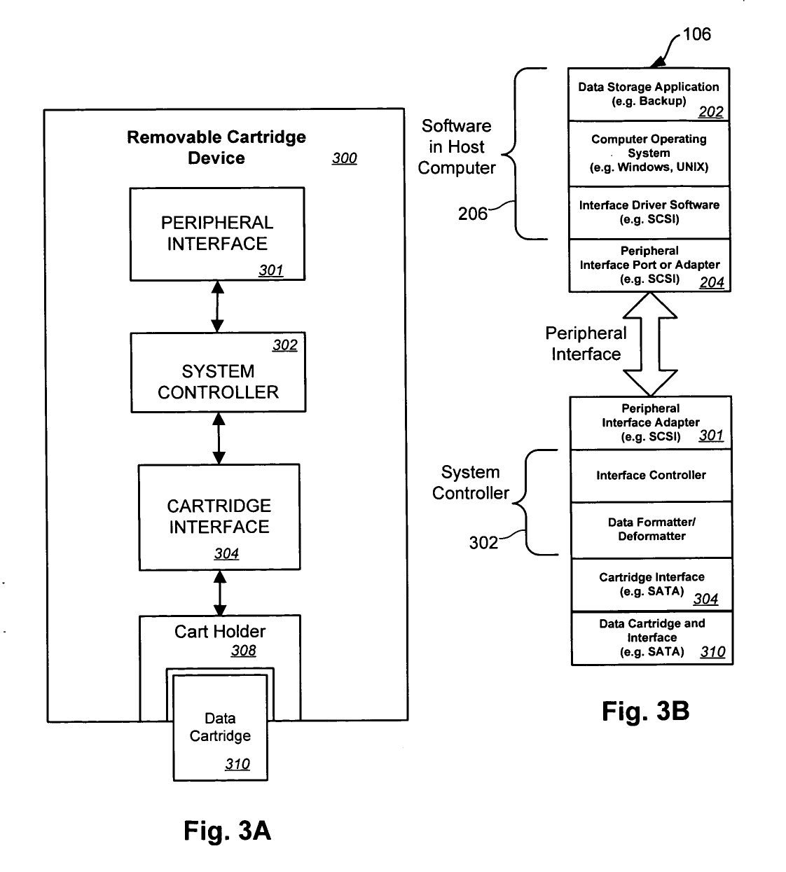

FIG. 3A shows an embodiment of the system diagram for a hardware-controlled removable cartridge device or drive 300 that generally includes four parts: a system controller 302, a peripheral interface 301, a cartridge interface circuit 304, and a cartridge holder or socket 308. The functions of the removable cartridge device 300 of FIG. 3A are similar to the tape drive 100 of FIG. 1, except that there is no tape mechanism as this embodiment of the removable cartridge device 300 has no moving parts required to read, write, format, or erase a data cartridge 310. Instead, all of the mechanics are enclosed inside the data cartridge 310.

The cartridge holder 308 and/or data cartridge 310 may have moving parts associated with locking the data cartridge 310 into the cartridge holder 308 or with loading or unloading the data cartridge 310. Normal data operations (e.g., read, write, format, or erase) do not require the removable cartridge device 300 to perform any mechanical actions. The cartridge holder defines a cavity or socket in which the data cartridge is placed to engage the data cartridge 310 to the removable cartridge device 300. The data cartridge 310 could partially extend from the socket 80% or less. In some embodiments, the data cartridge 310 is completely inserted into the socket, but any degree of insertion is possible. Some embodiments have a locking mechanism to keep the data cartridge 310 engaged with the removable cartridge device 300. An eject button and/or software command would disengage the lock for these embodiments.

The cartridge holder 308 has an electrical, optical and/or wireless interface to exchange data and commands with the data cartridge 310. The interface between the cartridge holder 308 and the data cartridge 310 could use a standard (e.g., SCSI, PATA, SATA, SAS, Firewire™, ethernet, UWB, USB, wireless USB, Bluetooth™, WiFi, etc.) or proprietary interface. In some embodiment, the protocol for this interface is a standard one, but the connector is proprietary.

FIG. 3B shows an embodiment of the software/hardware layer stack in both host computer 106 and the hardware-controlled removable cartridge device 300. To the host computer 106, the removable cartridge device 300 appears as any other tape drive 100 and/or autoloader. In one embodiment, the host computer 106 uses a SCSI protocol with a tape drive command set (e.g., SCSI Stream Commands) to control the removable cartridge device 300 and may use an autoloader command set (e.g., SCSI Media Changer). Without knowing, the data storage application 202 controls the data cartridge 310 that uses a different command set. The system controller 302 provides the translation between the two command sets. In this way, conventional data storage applications 202 can be used without modifications or special drivers and still operate with the data cartridge 310 normally.

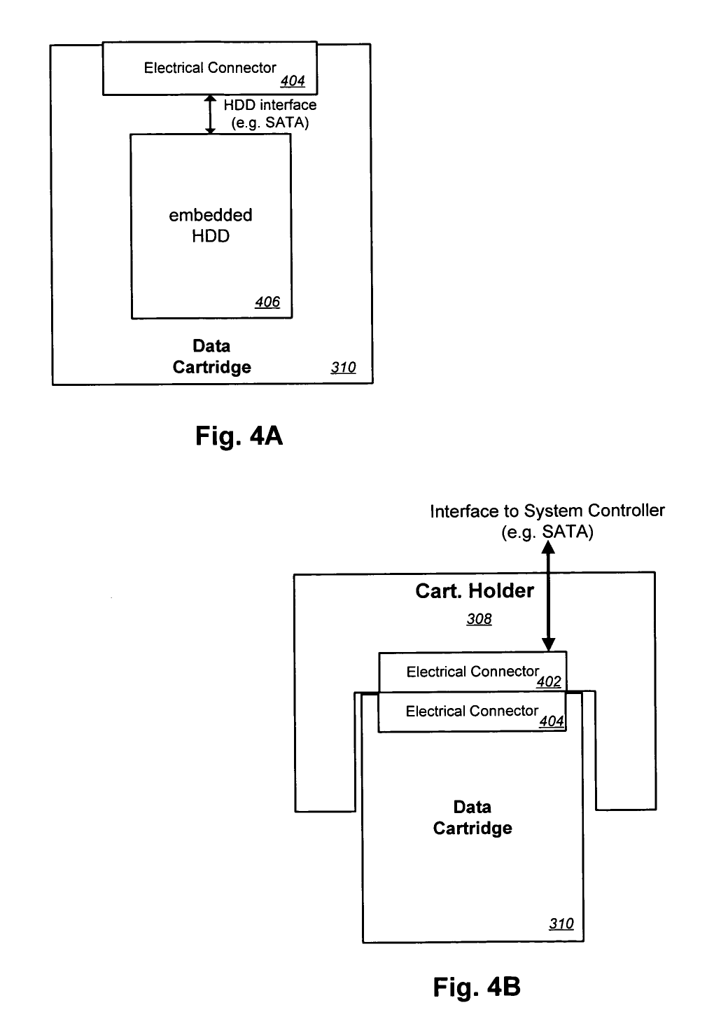

FIGS. 4A & 4B show detail of one embodiment of the data cartridge 310, the cartridge holder 308 and their connectors 402,404. The connectors 402, 404 of this embodiment mate to provide the electrical interconnection, but other embodiments could use an optical or radio frequency (RF) connection. In this embodiment, the connectors 402, 404 and cartridge interface 304 comply with a serial-ATA (SATA) or serial-SCSI standard, although other embodiments could use another serial or parallel interface. Some embodiments could have an optical connector coupled to a waveguide on the data cartridge 310 to allow passing a status light from the cartridge holder 308 to the data cartridge 310.

The cartridge holder 308 in this embodiment wires the electrical connector 402 to one on the host computer and provides a socket to accommodate the data cartridge 310. In some embodiments, the cartridge holder 308 is merely a cable from the host computer to the electrical connector 402 that can engage another connector 404 on the data cartridge. Other embodiments could couple the cartridge holder to the host computer 106 with any standard (e.g., SCSI, PATA, SATA, SAS, Firewire™, ethernet, UWB, USB, wireless USB, Bluetooth™, WiFi, etc.) or proprietary interface

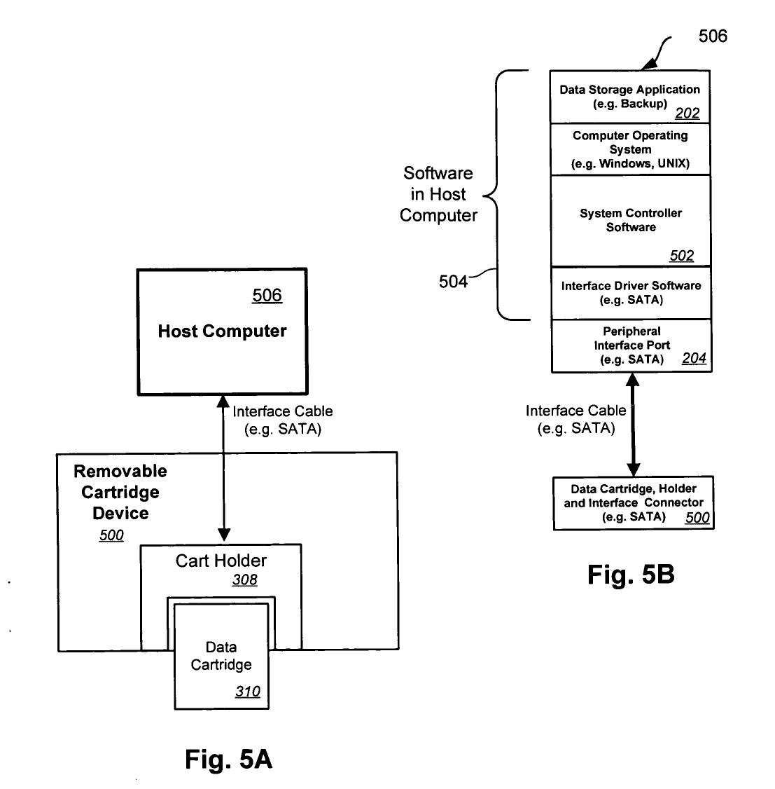

FIGS. 5A and 5B show another embodiment of a backup system. One basic idea of this embodiment relates to removing the peripheral interface 301, system controller 302 and cartridge interface 304 of FIG. 3A and replacing them with functions within the host computer 506. In addition to the functions performed by a device driver, the system controller software 502 also performs the data formatting/de-formatting and writing/reading operations performed by the system controller 302 in the hardware-controlled removable cartridge device 300 of the embodiment in FIG. 3A.

To the data storage application 202, the system controller software 502 appears like any other port driver that has a magnetic tape cartridge 106 attached. Translation is performed in the system controller software 502 to the actual interface driver (e.g., SATA driver) used to interface to the data cartridge 310. In this embodiment, the data storage application 202 communicates with a virtual SCSI driver using a tape drive command set (e.g., SCSI Stream Commands). This virtual SCSI driver is emulated by the system controller software 502. The virtual SCSI driver can sense when a data cartridge 310 is coupled to the peripheral interface port 204 of the host computer 506 and indicate to the data storage application 202 that a “tape” is available for storage or retrieval of information.

The hardware peripheral interface for this embodiment is directly the host computer 506 and the data cartridge 310 by way of a removable cartridge device 500. In this embodiment, the peripheral interface port 204 is a native SATA or SAS interface, but other embodiments could use other interfaces. This embodiment removes substantial cost from the removable cartridge device 300 by replacing some of the hardware and software in the removable cartridge device 300 with system controller software 502 that is run on the host computer 506. The data cartridge 310 has a native SATA or SAS interface that attaches to the SATA or SAS peripheral interface port 204 of the host computer 506.

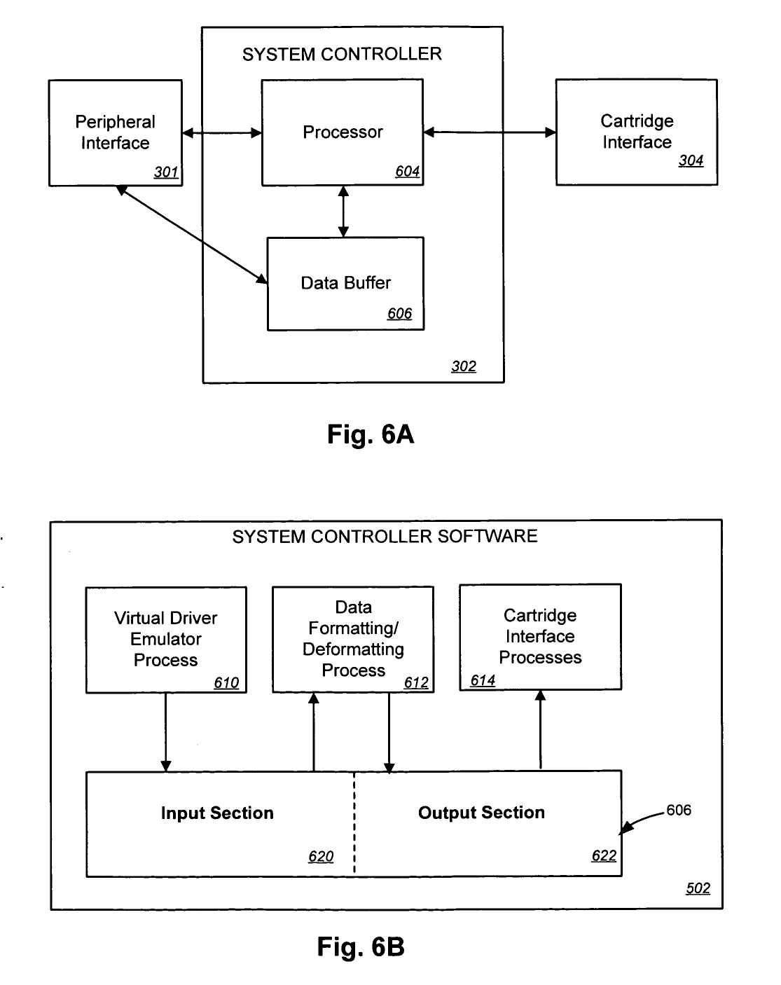

FIG. 6A shows a first embodiment of portions of the removable cartridge device 300 of FIGS. 3A and 3B. The processor 604 communicates with a data buffer 606, the cartridge interface 304 and the peripheral interface 301. Software or firmware running on the processor 604 manages this operation to allow translation of a first command set (e.g., SCSI Stream Commands) of the data storage application 202 to a second command set for the data cartridge 310 (e.g., SATA hard drive commands).

FIG. 6B shows an embodiment of the architecture of the system controller software 502, which implements the control and formatting functions that the hardware-controlled removable cartridge device 300 shown in FIG. 3A performs with hardware. The data buffer 606 has an input and output sections 620, 622. Under management of the virtual driver emulator 610, the input section 620 stores the commands and data of the host computer 506. Translation, reading/writing, formatting/deformatting, and compression/decompression is performed by the data formatting/deformatting process 612. The cartridge interface process 614 uses the output section buffer 622 when interacting with the data cartridge 310. The responses expected by the data storage application 202 are produced by the virtual driver emulator process 610.

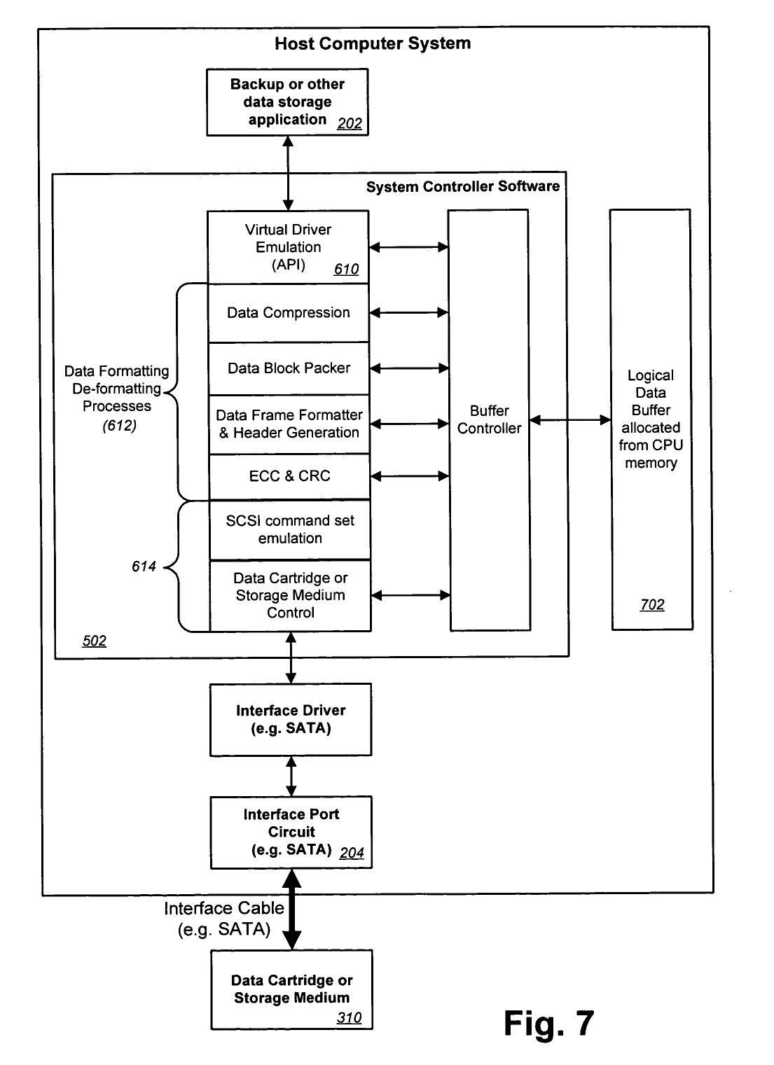

FIG. 7 shows an embodiment of the architecture of the host system components interacting with a data cartridge 310. In order to make the installed-based of legacy software applications 202 that expect the data storage peripheral to be connected to the host computer system 506 by a conventional interface such as SCSI, the system controller software 502 is designed to emulate the functions of a conventional peripheral interface driver at the driver's application programming interface (API). In this way, the backup or other application 202 can operate as it normally would without modification to support the data cartridge 310. But, the system controller software 502 adds the data formatting/de-formatting features used to write/read the data in the format or command set of the data cartridge 310. These features include data buffering of the data stream from the backup application, data compression, data packing, data structure formatting, error correction coding, CRC generation, and error recovery procedures. The system controller software 502 executes on the host computer 506 and uses its system memory resources 702 (e.g., DRAM) for the data buffering operations. The output of the system controller software 502 is to a conventional port driver in this embodiment, such as SATA, which in turn controls the hardware interface (e.g., SATA) to the data cartridge 310. It should be appreciated that such an architecture is not limited to removable storage media and will also work with permanently installed devices such as HDDs as long as the entire interface to the medium is non-mechanically actuated during data transfer.

In one embodiment, the system control software 502 and the system controller 302 appear the same from the perspective of the data storage application 202. Both embodiments could also have interchangeable data cartridges 310. A user may have access to both a hardware-controlled removable cartridge device 300 (e.g., the embodiment of FIG. 3A) and a software-controlled removable cartridge device 500 (e.g., the embodiment of FIG. 5A). The same cartridge 310 could be used in either the hardware- or software-controlled versions 300, 500 without any format difference in the cartridge 310. If there were format differences between the two devices 300, 500, translation could be done such that they were compatible.

One of the drawbacks of the SATA interface specification is that it does not provide all of the commands normally associated with a tape drive typically used in a backup restore/operation. One of the benefits of one embodiment of this architecture is that the SCSI interface is used by the backup application 202 without recoding the backup application for the native interface for the data cartridge 310. The system controller software 502 provides for SCSI command set emulation to translate traditional SCSI commands into SATA command sequences that are used by the data cartridge 310. Other embodiments could use different interface specifications.

While the principles of the invention have been described above in connection with specific apparatuses and methods, it is to be clearly understood that this description is made only by way of example and not as limitation on the scope of the invention.

What is claimed is:

1. A storage system for emulating a first interface command set different from a second interface command set of a second interface, the storage system comprising:
an interface connector configured to removably couple with a storage cartridge comprising the second interface, wherein the storage cartridge uses the second interface command set;
an interface circuit coupled to the interface connector;
an interface driver that manages operation of the interface circuit; and
a cartridge controller that uses the first interface command set and that is logically coupled to the interface driver, wherein:
the cartridge controller translates the first interface command set for the interface driver.
the first interface command set is for tape drives.

2. The storage system for emulating the first interface command set different from the second interface command set of the second interface as recited in claim 1, wherein:
the cartridge controller comprises a driver emulator that appears to application software as a driver emulator, wherein the driver emulator is driven by the application software, and
a cartridge interface function passes translated commands to the interface circuit.

3. The storage system for emulating the first interface command set different from the second interface command set of the second interface as recited in claim 1, wherein the storage cartridge comprises a rotating disk media.

4. The storage system for emulating the first interface command set different from the second interface command set of the second interface as recited in claim 1, wherein:
the storage cartridge comprises solid state media, and
storage of the storage cartridge has no moving parts.

5. The storage system for emulating the first interface command set different from the second interface command set of the second interface as recited in claim 1, wherein the first interface command set includes at least one of a SCSI Stream Command set or a SCSI Media Changer command set.

6. The storage system for emulating the first interface command set different from the second interface command set of the second interface as recited in claim 1, wherein the interface circuit is integral to a motherboard of the storage system.

7. The storage system for emulating the first interface command set different from the second interface command set of the second interface as recited in claim 1, wherein the interface circuit is chosen from a group of SATA, PATA, SCSI, SAS, IEEE1394, wireless USB, and USB.

8. The storage system for emulating the first interface command set different from the second interface command set of the second interface as recited in claim 1, wherein the interface driver is a standard interface driver.

9. The storage system for emulating the first interface command set different from the second interface command set of the second interface as recited in claim 1, wherein the storage cartridge does not use a tape media.

10. The storage system for emulating the first interface command set different from the second interface command set of the second interface as recited in claim 1, wherein the storage cartridge comprises a cartridge body configured for removable insertion of at least 20% of a length or width of the cartridge body into a holder, wherein the interface is within a cavity defined by the holder.

11. The storage system for emulating the first interface command set different from the second interface command set of the second interface as recited in claim 1, further comprising archiving software communicating to the cartridge controller using the first interface command set, whereby the storage cartridge is controlled by the archiving software.

12. The storage system for emulating the first interface command set different from the second interface command set of the second interface as recited in claim 1, wherein the storage cartridge comprises:
a cartridge body;
a cartridge connector configured to removably couple to the interface connector; and
a storage medium coupled to the cartridge connector.

13. The storage system for emulating the first interface command set different from the second interface command set of the second interface as recited in claim 1, wherein the storage cartridge comprises:
a cartridge body;
a cartridge connector configured to removably couple to the interface connector; and
a disk drive directly coupled to the cartridge connector.

14. A computer system for archiving data on an external storage cartridge, the computer system comprising:
an application layer comprising an archiving application;
a device driver layer comprising a standard interface port driver;
a standard interface port interruptedly coupled to the external storage cartridge; and
a cartridge controller that translates a first command set of the archiving application into a second command set of the standard interface port driver.

15. The computer system for archiving data on the external storage cartridge as recited in claim 14, further comprising:
an interface connector configured to removably couple with the external storage cartridge, wherein the standard interface port uses the interface connector;
an interface circuit coupled to the interface connector, wherein:
the interface circuit is at least part of the standard interface port,
the standard interface port driver manages operation of the interface circuit,
the cartridge controller uses the first interface command set,
the cartridge controller is logically coupled to the standard interface port driver, and
the first command set is customized for tape drives.

16. A storage sub-system that emulates a tape drive to application software, the storage sub-system comprising:
a driver emulator that appears to the application software as an interface driver, wherein the driver emulator is driven by the application software; and
a cartridge interface function that passes translated commands to a native computer interface, wherein:
the native computer interface includes a circuit, a driver and a media port, and
the media port can be interruptibly coupled to a data cartridge to store data for the application software.

17. The storage sub-system that emulates the tape drive to application software as recited in claim 16, further comprising:
an application layer comprising an archiving application;
a device driver layer appearing to have access to the standard interface port driver; and
a cartridge controller that translates a first command set of the archiving application into a second command set of the standard interface port driver, wherein the second command set is used for the native computer interface.

18. The storage sub-system that emulates the tape drive to application software as recited in claim 16, wherein the data cartridge comprises a hard drive.

19. The storage sub-system that emulates the tape drive to application software as recited in claim 16, wherein the native computer interface uses a protocol chosen from a group consisting of: SCSI, PATA, SATA, SAS, Firewire™, ethernet, UWB, Bluetooth™, USB, wireless USB, and WiFi.

20. The storage sub-system that emulates the tape drive to application software as recited in claim 16, wherein the data cartridge includes a rotating disk drive that is coupled directly to a second media port that can be coupled to the media port of the native computer interface.
